(19) United States
(12) Patent Application Publication
(10) Pub. No.: US 2025/0254512 A1
(43) Pub. Date: Aug. 7, 2025

(54) METHODS FOR FEDERATED LEARNING AS A NETWORK SERVICE (FLAAS) WITH USER CONSENT

(71) Applicant: INTERDIGITAL PATENT HOLDINGS, INC., Wilmington, DE (US)

(72) Inventors: Achref Methenni, Montreal (CA); Ulises Olvera-Hernandez, Saint-Lazare (CA); Alec Brusilovsky, Downingtown, PA (US); Samir Ferdi, Kirkland (CA); Zhibi Wang, Woodridge, IL (US); Jung Je Son, Warrington, PA (US); Guanzhou Wang, Brossard (CA); Morteza Kheirkhah, London (GB)

(73) Assignee: INTERDIGITAL PATENT HOLDINGS, INC., Wilmington, DE (US)

(21) Appl. No.: 18/856,226

(22) PCT Filed: May 5, 2023
(86) PCT No.: PCT/US2023/021184

§ 371 Date: Oct. 11, 2024

Related U.S. Application Data
(60) Provisional application No. 63/338,734, filed on May 5, 2022.

(51) Int. Cl. H04W 8/18; H04W 60/00

(52) U.S. Cl. CPC H04W 8/18; H04W 60/00

(57) ABSTRACT

A method and apparatus for supporting artificial intelligence/machine learning (AI/ML) operating are provided herein. A network node may receive a request to subscribe for notifications indicating consent provided by one or more wireless transmit receive units (WTRUs) to AIML operation supporting service enhancement. The network node may receive a registration request message including an indication that the WTRU provides consent to AI/ML operation supporting at least one type of service enhancement, and a service capability container indicating one or more service capabilities of the WTRU. The network node may send a registration response message indicating that a consent status associated with the WTRU is active for one or more applications. The network node may send a notification message indicating consent provided by the randomly selected WTRU to AI/ML operation supporting service enhancement for at least one of the one or more applications.

### CROSS-REFERENCE TO RELATED APPLICATIONS

This application claims the benefit of U.S. Provisional Application No. 63/338,734, filed May 5, 2022, the contents of which are incorporated herein by reference.

### BACKGROUND

Member selection may be an important step in federated learning (FL) training operations. In many cases, an artificial intelligence/machine learning (AI/ML) application may direct a request to multiple wireless transmit/receive units (WTRUs). Resource waste may occur, for example, if a 5G network must check or verify whether a large number of WTRUs may participate in an application layer AI/ML training operation. An AI/ML application may select one or more WTRUs from a larger group of WTRUs. In such a context, the selection of members for AI/ML operations, such as FL, may need to satisfy one or more requirements for diversity and eventually for efficiency of the node. In contrast to an inference task in which the application client at the WTRU side may be running and using an AI/ML process to provide an output, a training task may be considered a background task, meaning it may not require a WTRU to be actively performing an inference task. For a training step, the AI/ML operation may not necessarily need a particular WTRU, especially for WTRU group-based training.

### SUMMARY

A method and apparatus for supporting artificial intelligence/machine learning (AI/ML) operating are provided herein. A network node may receive a request to subscribe for notifications indicating consent provided by one or more wireless transmit receive units (WTRUs) to AIML operation supporting service enhancement. The network node may receive a registration request message including an indication that the WTRU provides consent to AI/ML operation supporting at least one type of service enhancement, and a service capability container indicating one or more service capabilities of the WTRU. The network node may send a registration response message indicating that a consent status associated with the WTRU is active for one or more applications. The network node may send a notification message indicating consent provided by the randomly selected WTRU to AI/ML operation supporting service enhancement for at least one of the one or more applications.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a message flow diagram illustrating an example of a volunteering request/proposal for artificial intelligence/machine learning (AI/ML) support; and

FIG. 3 is a message flow diagram illustrating another example procedure in which a WTRU volunteers to support AI/ML operations.

### DETAILED DESCRIPTION

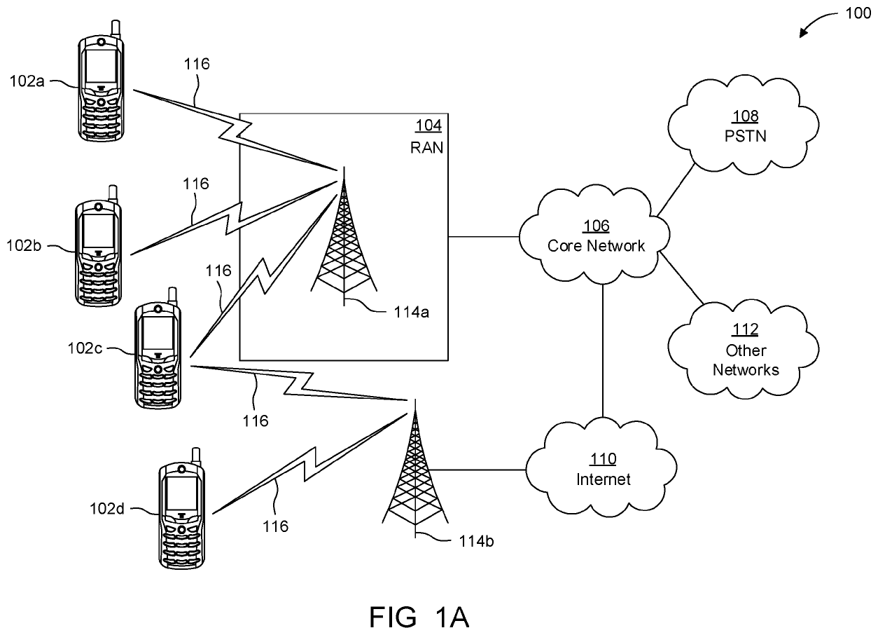

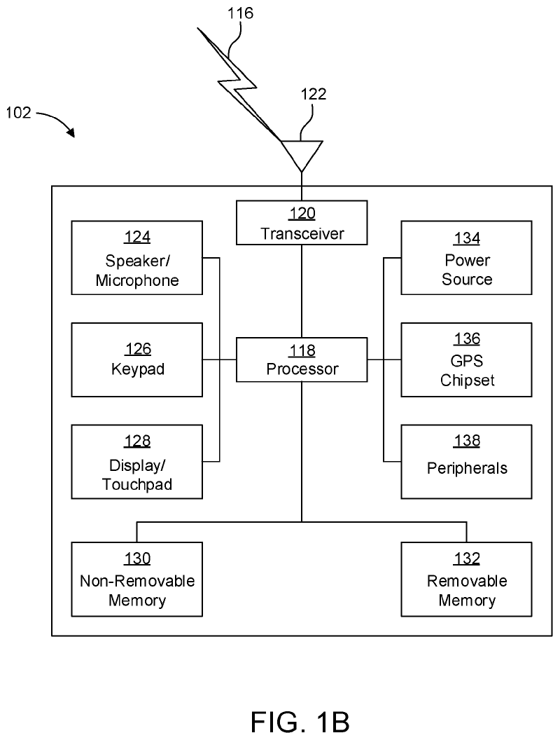

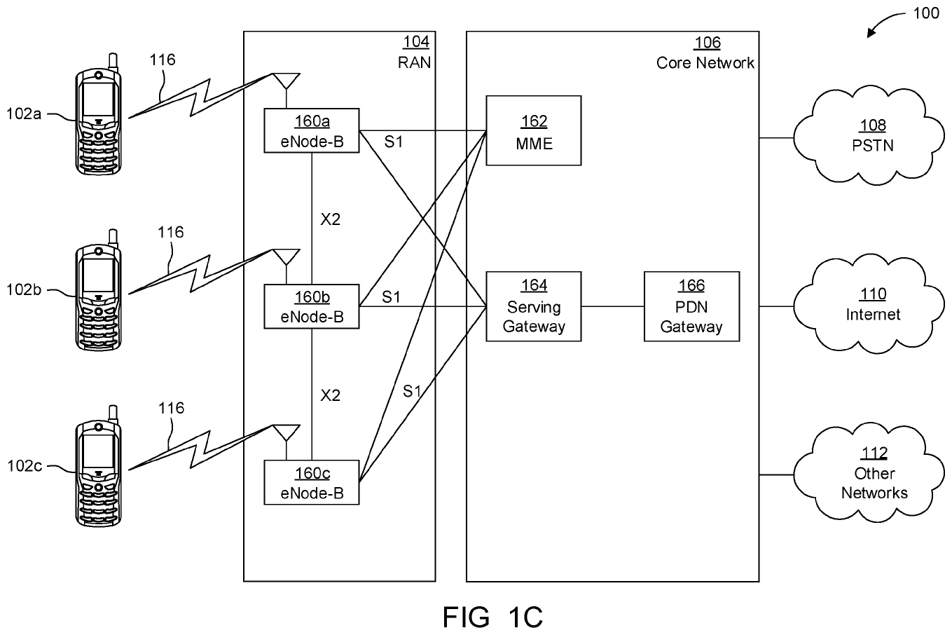

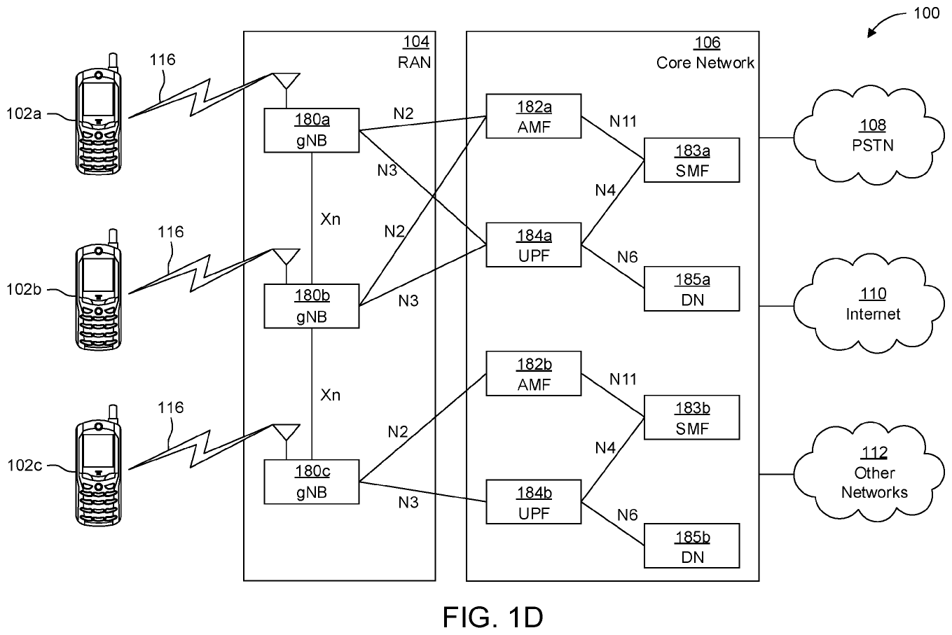

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a. 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Motivations for a user to volunteer WTRU resources for Application Layer AI/ML operations, or other services, are described herein.

In exchange for the user of a WTRU to providing their consent and thus participating in or volunteering for service enhancement operations, such as operations providing AI/ML FL support, a WTRU's user may require some motivation, incentive, or some benefit for being involved in such activity.

Some of the advantages, incentives, benefits or other motivators for participation are as follows. A mobile network operator (MNO) may facilitate privacy for the WTRU when it takes part in this activity. An MNO may provide an incentive to motivate WTRUs to volunteer to provide AI/ML support. Such compensation may be in the form of a discount on a specific service, access to “sponsored” connectivity services, and so on. A WTRU may acquire new expertise or improve their expertise in AI/ML operations support. It should be noted that an operation as described herein may not necessarily require participation by a particular WTRU (especially for WTRU group-based training).

Means for conveying a user's desire to volunteer WTRU resources are described herein. A WTRU and/or a user that has decided to volunteer WTRU resources may provide additional information to inform the network that they are willing or able to provide assistance in enhancing services, (e.g., in FL and other AI operations). When a WTRU with appropriate capabilities is present in a certain area, the WTRU may be already exchanging data with other applications. If the WTRU is aware that the network (i.e., one or more devices in a network) or server requires AI/ML FL support, a WTRU may volunteer with the network/server to assist with this operation. The WTRU may, for example, provide their consent to help the network optimize services that the User may benefit from. The terms “consent” and “volunteer” may be used interchangeably herein.

A WTRU may be made aware of some services for which WTRU resources may be welcome when supporting certain services, (e.g., AI/ML or FL). If some of these services are being used in the vicinity of the user or WTRU, the user and/or WTRU may choose to subscribe to services, such as AI/ML event notification, for example, if permitted or if consented to by the User.

A user and/or a user's WTRU may express such consent to help/support services offered by applications running in a 3GPP 5GS, (e.g., AI/ML or FL training operations), and may convey their consent to provide assistance to the 5G network.

An expression that the WTRU is to volunteer or otherwise provide assistance may be dynamic in some cases. In some cases, it may not be fixed or static; for example, the consent may be provided on a subscription-basis. A WTRU's participation may be subject to basic requirements or capabilities. For example, a WTRU may be unable to participate or volunteer or consent if certain requirements or capabilities (e.g., battery power, location, processing capabilities, link quality, etc.) are not met or satisfied. Elements of various solutions are described in greater detail in the following paragraphs.

Various acronyms as used herein may be defined as follows:
5GS: 5G System
AF: Application Function
AI: Artificial Intelligence
AI/ML: Artificial Intelligence/Machine Learning
AMF: Access and Mobility Management Function
FL: Federated Learning
ML: Machine Learning
MNO: Mobile Network Operator
NAS: Non-Access Stratum
PCF: Policy and Charging control function
PDU: Protocol Data Unit
SMF: Session Management Function
SMS: Short Message Service
UDM: Unified Data Management Function
UPF: User Plan Function
UE: User Equipment
WTRU: Wireless Transmit/Receive Unit

It should be noted that various systems and functions, such as the AF, AMF, SMF, UPF, or UDM, may be implemented in software or instructions executed by a circuit (e.g., an integrated circuit, FPGA, etc.) or processor located at a network node or device, such as a server, a computing platform, or a WTRU. These systems and functions may be described as performing various tasks and procedures but should be understood to be interchangeable with the software or processor performing such various tasks and procedures.

Additionally, though various actions may be described as being performed by a user, it should be understood that such actions may be performed by a WTRU. The terms user and or WTRU may, in some cases, be used interchangeably. For example, an expression of “consent” by a “user” to provide assistance to a network for AI/ML operations may manifest in the transmission of a message, by a WTRU, indicating that a user of the WTRU has consented to the provision of such information. A “decision” to “consent” or “volunteer” to provide assistance to a network for AI/ML operations may be made by a user, or by software or logic implemented, for example, by the user's WTRU. Consequently in some examples, as used herein, the terms “consent” or “volunteer” may be used to refer to a situation in which the software or hardware implemented in a WTRU may independently make a determination to express such consent or volunteer to provide assistance for AI/ML operations. Similarly, the terms “consent” or “volunteer” may also be used to refer to a situation in which the user of a WTRU decides to provide consent or volunteer to provide assistance for AI/ML operations, and provides an indication of such consent or decision to volunteer via their WTRU. In an example, the user may provide consent or volunteer by providing input via a user interface, which causes the WTRU to send a message to the network consenting on the user's behalf, or indicating the user's decision to consent or volunteer. It should also be understood that for aspects of the embodiments described herein concerning the location of a user or a location of a WTRU, the user and their WTRU may be co-located in some situations. In other situations, the user may be operating the WTRU remotely, and hence their locations (e.g., geographic vicinity, serving cell, tracking area, etc.) may differ.

Embodiments as described herein may address at least three different requirements for wireless systems. For instance, subject to user consent, operator policy and regulatory requirements, a 5G system may be able to expose information (e.g., information about candidate WTRUs) to an authorized third party to assist the third party in determining member(s) of a group of WTRUs (e.g., WTRUs of a FL group). A 5G system may be able to provide event alerting to an authorized third party, for instance, together with a predicted time of the event. Such alerts may be relevant to traffic congestion or movement of a WTRU into/out of different geographical areas. Based on operator policies, a 5G system may be able to provide means to allow an authorized third-party to monitor the resource utilization of a network service that is associated with the third party.

Furthermore, embodiments described herein may address aspects relating to key issues as set forth by standards setting organizations, such as the Third Generation Partnership Project (3GPP). For instance, the exposure of 5G Core Network (5GC) information to authorized third parties for application layer AI/ML operation may be addressed. It may be necessary for a 5GC to expose different types of assistance information to an AF for AI and/or ML operation. The embodiments described herein may address whether assistance information and/or events are exposed from a 5GS to an AF, what assistance information and/or events are exposed from 5GS to AF, and/or as the prediction of WTRU and/or network conditions and performance (e.g., location, QoS, load, congestion, etc.). User consent may be assumed for WTRU-related information. Hence, at least one problem addressed may be how the 5GS assists the AI/ML AF while protecting the User's privacy, to determine available resources within one or many WTRUs, at specific, locations, at a specific time, for a particular application layer AI/ML operation.

Another key issue addressed may be the provision of 5GS assistance for Federated Learning (FL) operation. Embodiments described herein may describe whether and how the 5GS provides assistance to an AF and to a WTRU for the AF and WTRU to manage the FL operation and model distribution/redistribution (i.e. FL member selection).

Embodiments may address assistance for selection of WTRUs for FL operation. Some embodiments may address whether, how, and/or what information provided by the 5GC to the AF can help the AF to select and manage the group of WTRUs that will be part of FL operation. Some embodiments may address whether, how, and/or what information is required by the 5GC in order to assist the AF for selecting and managing the group of WTRUs which will be part of FL operation. Hence, at least one problem addressed may be how the 5GS aids in the selection of Federated Learning (or any other Application Layer AI/ML operation) members, while maintaining a balance between system load and Application Layer AI/ML operation efficiency.

Some proposed solutions to the above noted issues and problems may involve any of the following steps, actions, or occurrences. It should be noted that although various solutions suggested or disclosed herein may be described

In some solutions, an AF may subscribe to event notifications from the 5GS to expose WTRUs that have provided user consent to participate in specific network driving enhancing services, such as AI/ML FL operations support. The event notifications may

In some solutions, a WTRU, based on prior agreement(s) with an MNO and possibly an ASP, may provide its consent to participate in service enhancing operations. The WTRU may provide consent using existing NAS-based procedures (or other logically equivalent procedures) such as a mobility registration request, when triggered by network events. Examples of network events may include a location change that triggers the WTRU to send the mobility registration request, a change in the WTRU's capabilities, a change in the WTRU's protocol parameters, or a change in a set of network slices that the WTRU is allowed to use. In some solutions, the WTRU may provide consent in response to, or when triggered by Application Layer events, or when downloading data related to a new service enhancing application.

In some solutions, the 5GS may notify an AF about WTRUs that have expressed their desire to support service enhancing procedures, by, for example, asserting their consent through a NAS-based procedure or through a logically equivalent procedure.

In some solutions, an AF, using application layer mechanisms, based on or in response to a notification from the 5GS, may contact WTRUs that have expressed their consent

Triggers that may prompt a WTRU to volunteer consent to support AI/ML FL training are described herein. A WTRU, or a user of a WTRU, may be given an option, such as during a procedure for or message exchange providing an initial WTRU configuration, to opt in or out of participation in service enhancements for services that may benefit the WTRU's user. For example, the WTRU or the user of the WTRU may benefit from an application for which data is stored (e.g., preloaded or post-loaded) in the WTRU that in turn benefits from network-provided services. The user's consent, i.e., an explicit indication of the user's consent, may be stored possibly separately in associated with each application for which consent ID basis. The user's consent may be stored, for example, in the UDM as part of the WTRU subscriber record. The user's consent may be revoked or reinstated (for example, deactivated or reactivated) at any time. A user may assert or express their desire to participate in a service enhancement by providing their consent, for example, during a Registration Request procedure. The WTRU may use a message (e.g., a UL NAS TRANSPORT message or another logical equivalent) to convey the User's consent to participate in a service enhancement.

The initial configuration in the UDM may be static. The initial configuration may indicate that the WTRU is allowed to provide consent to participate in a service enhancement. The WTRU or user may need to activate such participation, (e.g., by expressing consent), to be considered as a resource for a particular service operation. Likewise, if the WTRU or user has expressed consent, the WTRU or user may revoke this consent at any time, however this does not imply that the WTRU or user is no longer allowed to participate in a service enhancement.

The AMF may verify, (e.g., in subscriber records), whether the WTRU is allowed to volunteer for a service enhancement by providing its consent. In some cases, the AMF may do so by checking Access and Mobility Subscription Data that has been received, accessed, or stored by the UDM or by checking the PCF. For example, a new policy may be introduced to associate the WTRU with a service enhancement.

A User or WTRU may download an application that may benefit from Application Layer AI/ML operation or another service. If applications that may benefit from AI/ML operation are managed by an ASP that has a business relationship or other arrangement with the MNO, the ASP may provide the MNO with a list of subscribers that are registered at the application layer level and that may be authorized to provide service enhancements, for example, in a particular Area of Interest, at a particular time and/or even for a particular S-NSSAI/DNN combination. Alternatively, or additionally, the ASP may indicate whether it is willing to receive notifications for WTRUs that have expressed consent to participate in service enhancement, (e.g., by using a specific group ID), without a need to identify a specific WTRU.

The AF may subscribe, for example, via the NEF or directly to the UDM for event notifications indicating user consent for a particular service enhancement. The AF may indicate in a subscription request whether the notification is for specific WTRU(s) or for WTRUs associated with a group ID. As part of the notification event, the UDM may provide the AF with the address or addresses of WTRU(s) asserting their consent to participate in service enhancement with the relevant AF.

It should be noted that although the ASP and the WTRU may negotiate the service, just by enabling the application, by having WTRUs' Users to assert their consent through the MNO, the ASP may benefit from 5GS support, which may provide a transport path specifically tailored for the service the ASP wants to deliver.

As described above, the WTRU may volunteer by expressing its consent to participate in service enhancements, such as when the WTRU enters a specific geographical area (which may be identified through GPS coordinates or specific TA(s)). In some cases, the WTRU's expression of consent to participate in service enhancements may be triggered by procedures that take place at the application layer. The WTRU may express consent, for example, when the User launches an application that may benefit from service enhancements, such as a video application that may employ AI/ML functionality. The Application Client in the WTRU may also trigger the activation or expression of user consent, for example, after the WTRU's user has completed an application layer enrollment procedure. When the WTRU asserts its consent, it may provide information (e.g., an application ID, operating system (OS) ID, and/or AI/ML operation type) to support service enhancements (e.g., Application Layer AI/ML operations). The WTRU may send the indication of its consent during a mobility registration update, or in a message such as an UL NAS TRASNPORT message. The AMF may update the Access and Mobility Subscriber data in the UDM. Whether the WTRU asserts its consent through a Registration procedure or UL NAS TRANSPORT procedure (or another logically equivalent procedure) may be specified in Access and Mobility Policies.

A WTRU may dynamically revoke its consent at any time, e.g., explicitly, based on direct user command, or implicitly, as a result of the expiration of a time duration or when the WTRU leaves a particular geographical area. Likewise, the operator may at any time update the Subscriber Record in the UDM, which may determine whether the WTRU is allowed to assert its consent for service enhancements.

In some cases, if the AF subscribes to UDM event notification indicating the WTRU's user consent to participate in service enhancements, the UDM may notify the AF accordingly when a WTRU has asserted its consent, or when the WTRU it has revoked it.

Using 3GPP procedures that may enable a WTRU to request network capability information in the form of one or more event notifications, which may be, for example, network slice congestion information event notifications, a WTRU may subscribe to service enhancement availability or network events notifications. The WTRU may receive notifications (i.e., provided via one or more messages) indicating that service enhancement(s) are available or indicating the occurrence of one or more network events. In some cases, to prevent high signaling load, e.g., as a result of services becoming available, the WTRU may receive one or more notifications piggybacked onto other procedures. For example, the notification may be delivered as part of a message, such as a Registration Accept message or a PDU Session Establishment accept message.

The WTRU may, based on or in response to user interaction, user feedback or user input, assert its consent or its user's consent by updating its user consent status, (i.e., active/inactive), upon receipt of a service enhancement notification. Thus, when relevant service enhancing procedures are available, such as for 5GS support for FL operations, the WTRU may be notified and the WTRU may update its consent status.

Service flows for consent volunteering procedures are described herein. Although the service flows described herein may illustrate discrete messages exchanged between discrete network functions, it should be well-understood by those of ordinary skill in the art that information carried by the illustrated messages may be carried in messages of other types and between other network entities.

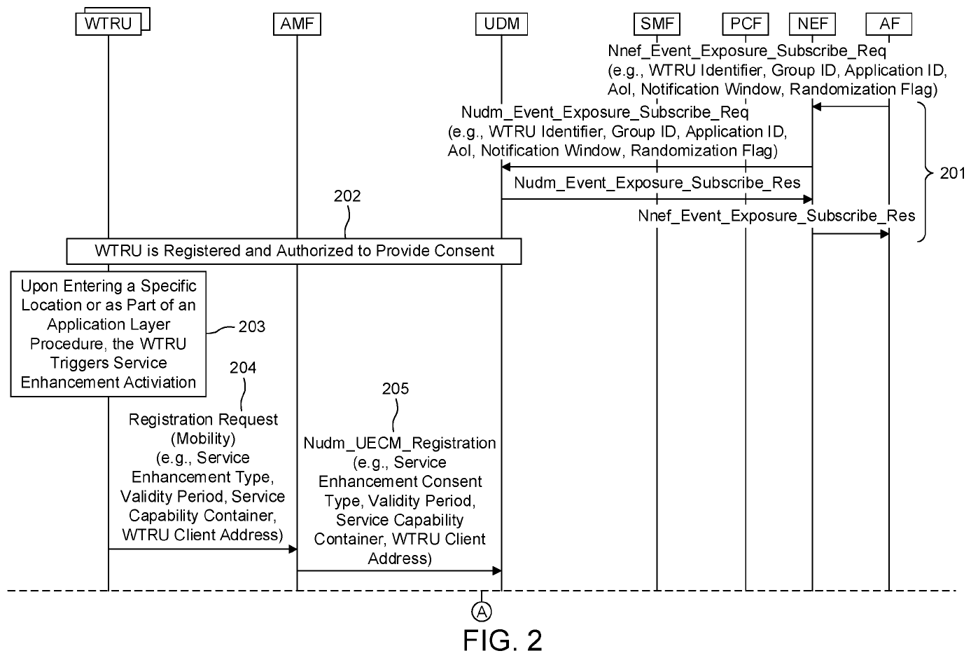

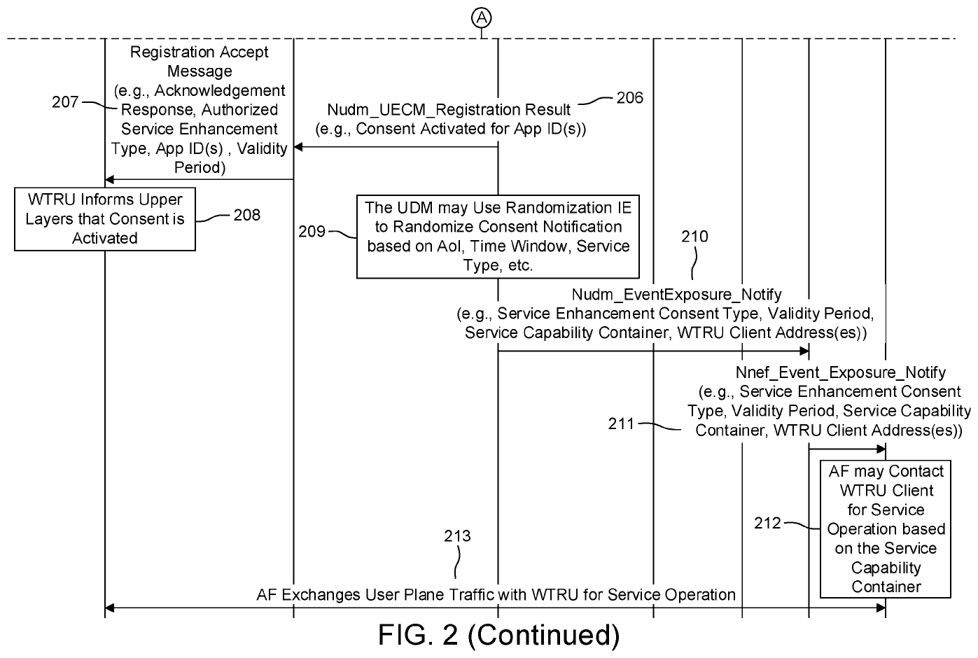

FIG. 2 is a message flow diagram illustrating an example of a procedure in which a WTRU volunteers, requests or proposes to participate in operations for AI/ML support. As shown in FIG. 2 at 201, messages may be exchanged among network functions enabling an AF to receive notifications concerning WTRUs that wish to participate or support service operations provided by the AF. For example, as shown at 201, an AF may send a request message to subscribe to Event Notifications relating to specific WTRU(s) or relating to any WTRU associated with a specific group ID. The request message may be sent to, for example, a UDM, or as shown in FIG. 2, to an NEF which may then forward the request message to the UDM. The request message may identify a specific service or application (e.g., AI/ML FL) and/or may indicate that one or more WTRUs have expressed consent to participate in service operation (e.g., AI/ML FL). The request may include parameters such as WTRU identifiers (for example, IP addresses or Global Public Subscription Identifiers (GPSIs) associated with one or more WTRUs), a group ID (e.g., if the request targets a group of WTRUs belonging to a certain group associated with the group ID), and/or an Application ID to identify a specific application for which the AF intends to receive consent notifications. The AF may subscribe to event exposure by the UDM to receive information regarding WTRU consent volunteering status, for example, whether one or more WTRUs have provided consent, whether one or more WTRUs are allowed to provide consent, and/or whether WTRU have modified (e.g., activated, deactivated) their consent volunteering status.

The request message may indicate an area of interest, which may identify, for example, an area for which the AF is interested in receiving notifications about volunteering WTRUs. The request message may also indicate a notification window to define a period of time during which the AF is interested in having volunteering take place, or a window of time during which the AF prefers to receive the notifications to which it is subscribing. The request may include a randomization flag. For instance, the AF may provide the UDM with information that enables random selection of WTRUs that have provided or will provide their consent to participate in particular service enhancement operations (considering, e.g., a time window and/or an Area of Interest). The UDM may, based on the presence of the randomization flag, utilize a bias reduction algorithm that ensures randomness in the selection of volunteers according to parameters provided by the AF.

The UDM, having received the request message, may send a response message to the AF or, as shown in FIG. 2, to the NEF, which may forward the response message to the AF. The response message may, for example, acknowledge receipt of the request message. The response message may indicate that the AF is successfully subscribed to notifications regarding the consent status of one or more WTRUs, or, in some cases, the response message may indicate that the AF has not successfully subscribed to such notifications.

As shown in the example of FIG. 2 at 202, a WTRU may be registered to the network and may have expressed consent to participate in a service enhancement operation.

If one or more conditions are fulfilled, such as the WTRU entering a geographical location, and/or as a result of an Application Layer operation, the WTRU may determine to update its consent to participate in a service enhancement operation. The service enhancement may provide an improvement in the performance of a certain task of the application (for example, improved video performance), which uses AI/ML training and inference and user data to perform these service enhancements.

The WTRU may communicate its consent through a mobility registration procedure. The WTRU may transmit a registration message, which may indicate a service enhancement type for which it is providing consent and/or the validity period through which this consent is valid. The WTRU may transmit the registration message to the network (e.g., a base station or another network entity implementing functions such as an AMF) as shown in the example of FIG. 2 at 203. The WTRU may provide an indication of its capabilities in a Service Capability Container, which may be interpreted based on the Service enhancement type. For instance, the WTRU may be interested in running an application that requires analytics, and if the WTRU wants to run a video application, for example, then by using said analytics, the performance of the video application may be enhanced. The WTRU may express its consent to use the service enhancement by including the Service Capability Container in one or more messages that are sent to the network. For instance, the Service Capability Container may be included in the registration message that the WTRU sends to the network.

In the example shown in FIG. 2, at 205, the AMF may relay service enhancement parameters to the UDM to indicate the WTRU's desire to assert its consent. In the scenario illustrated, the WTRU is assumed to activate its consent or modify it.

As shown at 206, the UDM may send an acknowledgment message to the AMF to confirm the provisioning/approval and storage of contextual information regarding the WTRU's volunteering consent. In this acknowledgment message, the UDM may include an indication of the different enhancement types that the WTRU has been authorized to volunteer consent for. The UDM may include an indication of the area of interest and/or the time window for which the WTRU is authorized to volunteer. The area of interest and/or time window indicated in the acknowledgement message may not necessarily be the same area of interest and/or time window that was provided by the WTRU/AMF in previous steps. For example, the area of interest and/or time window indicated in the acknowledgement message may be a subset of the area of interest and time windows that the WTRU/AMF provided previously. The acknowledgement message may include an indication that WTRU consent is activated for one or more applications (e.g., applications X and Y). For example, the acknowledgement message may include application IDs associated with applications X and Y.

As shown at 207, the AMF may send the registration accept message to the WTRU. This message may include an indication of the acknowledgment of the consent volunteering, in addition to the authorized Service enhancement types authorized, and a validity period for the volunteering. This message might also include a list of the different application IDs for which the WTRU was authorized to volunteer consent.

As shown at 208, the WTRU informs upper layer(s) that consent is activated. The WTRU may update parameters for executing application layer functions based on the activation of its consent. For instance, the WTRU may be configured (or reconfigured) to provide assistance to the network or report information (e.g., training data) in support of AI/ML service operations. The WTRU may be configured (or reconfigured) to be contacted or to receive requests from the network (e.g., the AF) for service operations.

At 209, the UDM may, based on the provided randomization information, selectively choose to issue consent notifications for one or more WTRUs (i.e., including the WTRU illustrated in FIG. 2), based on one or more parameters including the Service Enhancement type, time window or area of interest. For example, the UDM may selectively choose to issue consent notifications for one or more WTRUs for whom their consent is active or is provided during the time window indicated by the AF, and/or WTRUs that are present within the area of interest indicated by the AF. The UDM may choose to issue consent notifications for one or more WTRUs whose indicated service enhancement capabilities permit participation in AI/ML operation. The UDM may choose to issue consent notifications to specific applications selectively based on the service enhancement types for which the one or more WTRUs have consented. The UDM may update stored data indicating the Service Enhancement consent for the one or more WTRUs and/or trigger the transmission of an Event Exposure Notification to the AF (through the NEF). The UDM may send the notification to the AF as shown at 210, and the NEF may relay the Exposure Notification to the AF as shown at 211.

As shown at 212, the AF may determine whether a WTRU or group of WTRUs may be included as a member or members, for example, based on the specific application and based on WTRU capabilities (e.g., the capabilities provided in the Service Capability Container). If the AF decides to add the WTRU as a participant in current or future service operations, the AF may use the WTRU client address to contact the WTRU. As shown at 213, the AF may exchange traffic with one or more WTRUs for service enhancement (e.g., AI/ML assisted video enhancement application traffic).

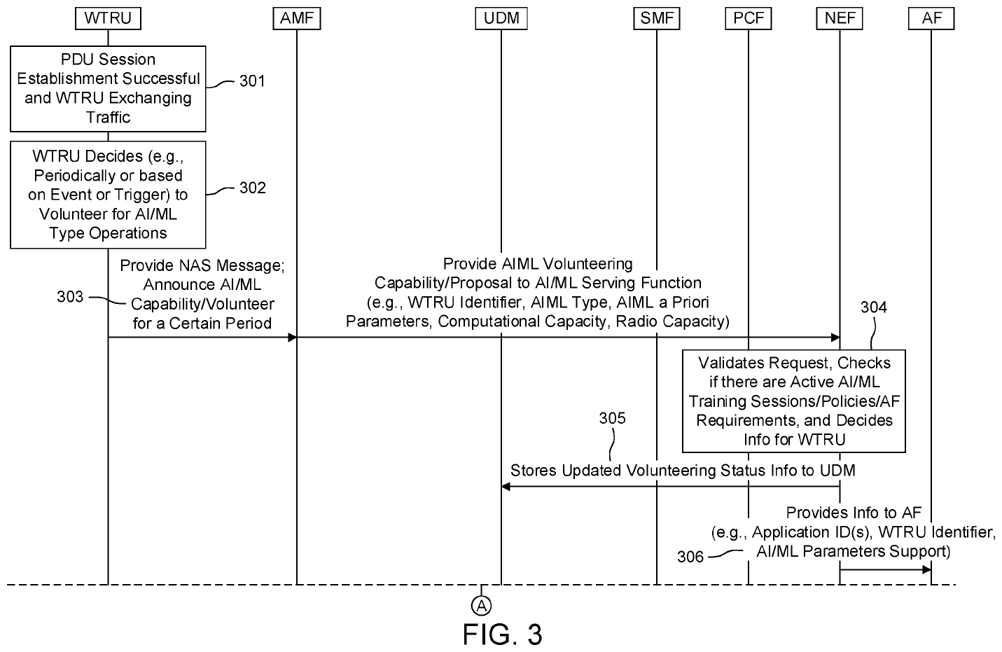

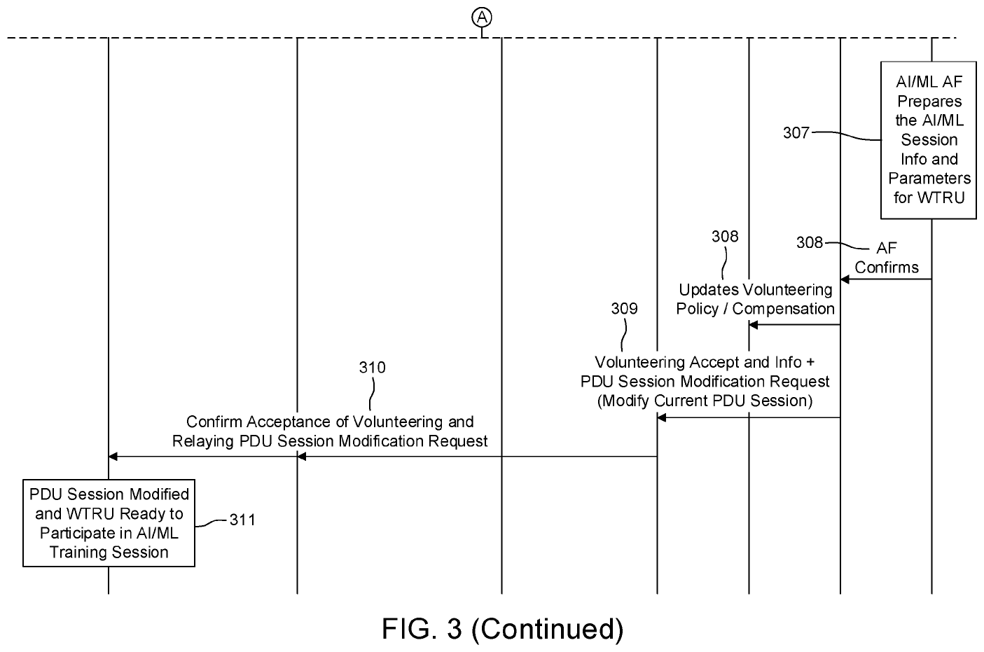

FIG. 3 is a message flow diagram illustrating another example procedure in which a WTRU volunteers to support AI/ML operations. The WTRU may be registered with the network and exchange messaging/data with the network. As shown at 301, a PDU session may have been established and the WTRU may be exchanging data with the network.

As shown at 302, the WTRU may determine whether to volunteer for AI/ML type operations. The WTRU may make such determination periodically or in response to the occurrence of an event or fulfilment of triggering conditions. Examples of triggering conditions for the decision are described in further detail in other portions herein. The WTRU may communicate its proposal to volunteer, for example, to the 5GC. The proposal may be provided to the 5GC, for instance, through a NAS MM message to the AMF as is shown at 303, or through another logically equivalent message.

The AMF may decapsulate the NAS message or logically equivalent message that communicates the WTRU's proposal to volunteer and forward it to the NEF as shown at 303. In the forwarded message, the WTRU may announce its volunteering consent and/or its AI/ML capabilities. The WTRU may announce its consent and/or its AI/ML capabilities for a certain period. The WTRU may provide some information regarding the training to which it consents. For example, the WTRU may indicate the type of operation, types of data it supports (voice, videos, text, etc.), and/or a maximum intensity (e.g., bit rate) that it is willing or able to support.

As shown at 304, the NEF may coordinate the PCF to verify whether there are active AI/ML-enhanced AF sessions and use the info provided by WTRU (possibly in addition to info from the UDM and/or UDR) to decide info for WTRU. The information may include, for example, a suitable time window during which the WTRU may volunteer, and/or one or more types of applications for which the WTRU may volunteer to provide AI/ML support. The AMF may verify with Policy volunteering consent rules to assist with AI/ML AF selection and WTRU volunteering selection by (e.g., applying anonymity requirements/preferences/incentive/fairness). Such verification may be carried out substantially as described in other paragraphs herein.

At 305, The NEF may send volunteering information to the UDM, which may then be stored as volunteering consent information. Alternatively, or additionally as shown at 306 in FIG. 3, the NEF may provide volunteering info to one or more AI/ML AFs to obtain feedback from them. One or more AFs may respond to the NEF, for example, with feedback indicating one or more WTRUs that may be used as a volunteer for a specific application. For instance, the feedback may indicate a preferred WTRU or list of WTRUs to be used as volunteers. If there are multiple candidate applications and/or training sessions that the WTRU may participate in, the network may send the volunteering info to multiple AI/ML FL AFs, and provide the WTRU with a list of choices as to which application and/or session to participate in. The WTRU may then decide which application and/or session to volunteer for. In some embodiments, The network may decide which FL AF the WTRU is to be associated with for this volunteering opportunity.

The AI/ML FL application may confirm through the AF whether it accepts this volunteering offer from WTRU. In the example shown in FIG. 3, the WTRU is approved by the AI/ML app for participation in this FL session. Hence, as shown at 307, the AI/ML AF may prepare AI/ML session info and parameters for the WTRU. Alternatively, the WTRU may not approve the WTRU for participation in the FL session. Alternatively, or additionally, the AI/ML AF may have a requirement that must be fulfilled for the WTRU to participate in the FL session. In any case, the AI/ML serving function may issue an acknowledgement of the WTRU's volunteering proposal, as shown at 308. The acknowledgment message may include information indicating whether the WTRU is approved for participation in the FL session. In some cases, the acknowledgement message may indicate confirmation/pre-approval to the network through the NEF. The acknowledgement message may include a PDU session establishment/modification request, e.g., to change the current PDU session, to the WTRU

The NEF, having received the confirmation message from the AF, may update one or more volunteering policies or compensation. As is further shown at 308, the NEF may provide volunteering consent selection related information to the PCF.

As shown at 309, the acknowledgement and PDU session request may be forwarded to the selected SMF (for example, to the serving SMF or to a new one if reselection is performed).

As shown at 310, The SMF may forward the message to the AMF, which may send the message to the WTRU through a NAS message or another logical equivalent.

As shown at 311, The WTRU may receive the acknowledgement and PDU session modification request from the network. The WTRU may approve the request, for example, absent any failure conditions. The WTRU may then perform PDU session modification and begin taking part in the FL training using the agreed upon rules and/or parameters.

In some scenarios, a WTRU may wish to establish a new PDU session for FL volunteering purposes. In such cases, the volunteering and session setup procedure may be performed in the same procedure. A WTRU may trigger PDU Session establishment for volunteering for the AI/ML service. During PDU session establishment, the SMF and/or PCF may contact the AF associated with AI/ML enhancement to notify the AF of the WTRU's volunteering info and to retrieve a required QoS level that must be met for the WTRU to be allowed to join in the AF's FL training. When a WTRU is not allowed to join the AF's FL training based on the feedback from AF, the SMF/PCF may reject the PDU session establishment request.

Methods for coordinated volunteering are described herein. In some methods, the AF may provide the UDM with information to enable random selection of WTRUs providing their consent to participate in particular service enhancement. The information may consider a time window and possibly area of interest information. The AF function may determine these parameters based on any number of factors or conditions.

The UDM may use a bias reduction algorithm (e.g., to introduce randomness in the selection of volunteers according to parameters provided by the AF). In addition, the UDM, may use policies to control traffic peaks. The UDM may control traffic peaks by limiting the amount of traffic for a particular service operation, such as Federated Learning for AI/ML applications.

The PCF may provide policies related to volunteering consent. The PCF may generate and/or manage rules to control traffic for a specific Application (while, for example, randomizing the selection of volunteers and/or making an unbiased selection).

Volunteering modes related to privacy are described herein. When volunteering to support AI/ML FL applications, one or more modes may be considered. In some modes, anonymous participation may be used. For example, anonymous participation may be ensured by providing consent in association with an application ID or group ID, which may not require a WTRU identifier. In such modes the network may need to make sure the identity of the WTRU is not provided to the AI/ML AF.

Some modes may involve non-anonymous participation, and a volunteering WTRU/user identity may be known to the AI/ML AF. In such scenarios, authentication/authorization with regards to the volunteering activity may originate or take place from the AI/ML AF, or the 5GC may provide the AI/ML AF with the WTRU/user identities.

Privacy may be desirable from the user's (or WTRU's) perspective, or imposed as a local regulatory requirement or a requirement from certain AI/ML applications. Depending on their policies, some AI/ML Applications (and even some FL applications) may require participants to be identified for the AI/ML activity. This may be a criterion for selecting the correct AI/ML AF and volunteering participants. PCF volunteering policies may be set up considering information about anonymity preferences, and the network may use such preferences additionally with AI/ML AF requirements, for example, to map WTRUs to appropriate applications.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A network node comprising:
a processor configured to receive a request to subscribe for notifications indicating consent provided by one or more wireless transmit receive units (WTRUs) to participate in an artificial intelligence/machine learning (AI/ML) operation supporting service enhancement for at least one application, the request to subscribe for notifications including a randomization flag enabling random selection of at least one of the one or more WTRUs for which a notification message is to be sent;
the processor configured to receive, from a WTRU, a registration request message including an indication that the WTRU provides consent to participate in an AI/ML operation supporting at least one type of service enhancement, a service capability container indicating one or more service capabilities of the WTRU, and an address associated with the WTRU;
the processor configured to send, to the WTRU, a registration response message indicating that a consent status associated with the WTRU is active for one or more applications, wherein the one or more applications utilizes the at least one type of service enhancement, and wherein the one or more applications utilize service enhancement for which the one or more indicated service capabilities of the WTRU permit the WTRU to participate in an AI/ML operation;
the processor configured to, based on the randomization flag, randomly select the WTRU; and
the processor configured to send a notification message indicating consent provided by the randomly selected WTRU to participate in an AI/ML operation supporting service enhancement for at least one of the one or more applications, and wherein the notification message includes the address associated with the WTRU.

2. The network node of claim 1, wherein the registration response message includes a list of applications for which the consent status associated with the WTRU is active.

3. The network node of claim 1, wherein the request to subscribe for notifications includes an indication of a first time period during which the AI/ML operation is to be carried out or during which notifications are to be sent, wherein the registration request message includes an indication of a second time period during which the consent status is valid; and wherein the WTRU is randomly selected on a condition the first time period and the second time period overlap.

4. The network node of claim 1, wherein the request to subscribe for notifications includes an indication of an area of interest, and wherein the processor is configured to send the notification message on a condition the randomly selected WTRU is within the area of interest.

5. The network node of claim 1, wherein the request to subscribe for notifications includes a group identifier associated with a group of WTRUs that includes the WTRU, and wherein the address associated with the WTRU is the group identifier.

6. The network node of claim 1, further comprising a memory device configured to store information indicating the consent status associated with the WTRU for the one or more applications.

7. A wireless transmit/receive unit (WTRU) comprising:
a processor; and
a transceiver;
the processor and the transceiver configured to send a registration request message including an indication that the WTRU provides consent to participate in an artificial intelligence/machine learning (AI/ML) operation supporting at least one type of service enhancement, a service capability container indicating one or more service capabilities of the WTRU, and an address associated with the WTRU;
the processor and the transceiver configured to receive a registration response message indicating that a consent status associated with the WTRU is active for one or more applications and indicating a period during which the consent status associated with the WTRU is active, wherein the one or more applications utilize the at least one type of service enhancement, and wherein the one or more applications utilize service enhancement for which the one or more indicated service capabilities of the WTRU permit the WTRU to participate in an AI/ML operation; and
the processor and the transceiver configured to receive, on a condition the period during which the consent status associated with the WTRU is active has not elapsed, a message from a network node initiating traffic for an AI/ML operation supporting at least one of the one or more applications.

8. The WTRU of claim 7, wherein the registration response message includes a list of applications for which the consent status associated with the WTRU is active.

9. The WTRU of claim 7, wherein the registration request message is sent on a condition the WTRU enters a geographical area.

10. The WTRU of claim 9, the processor and the transceiver configured to receive configuration information associated with service enhancement, the configuration information indicating an area of interest associated with one or more applications, wherein the area of interest at least in part overlaps with the geographical area.

11. The WTRU of claim 7, wherein the address associated with the WTRU is a group identifier associated with a group of WTRUs.

12. The WTRU of claim 7, wherein prior to the sending of the registration request message, the consent status associated with the WTRU is inactive for the one or more applications.

13-16. (canceled)

17. A method performed by a wireless transmit/receive unit (WTRU), the method comprising:
sending a registration request message including an indication that the WTRU provides consent to participate in an artificial intelligence/machine learning (AI/ML) operation supporting at least one type of service enhancement, a service capability container indicating one or more service capabilities of the WTRU, and an address associated with the WTRU;
receiving a registration response message indicating that a consent status associated with the WTRU is active for one or more applications and indicating a period during which the consent status associated with the WTRU is active, wherein the one or more applications utilize the at least one type of service enhancement, and wherein the one or more applications utilize service enhancement for which the one or more indicated service capabilities of the WTRU permit the WTRU to participate in an AI/ML operation; and
receiving, within the period during which the consent status associated with the WTRU is active, a message from a network node initiating traffic for an AI/ML operation supporting at least one of the one or more applications.

18. The method of claim 17, wherein the registration response message includes a list of applications for which the consent status associated with the WTRU is active.

19. The method of claim 17, wherein the registration request message is sent responsive to a determination that the WTRU has entered a geographical area.

20. The method of claim 19 comprising receiving configuration information associated with service enhancement, the configuration information indicating an area of interest associated with one or more applications, wherein the area of interest at least in part overlaps with the geographical area.

21. The method of claim 17, wherein the address associated with the WTRU is a group identifier associated with a group of WTRUs.

22. The method of claim 17, wherein prior to the sending of the registration request message, the consent status associated with the WTRU is inactive for the one or more applications.
